(19) United States
(12) Patent Application Publication
(10) Pub. No.: US 2004/0133594 A1
(43) Pub. Date: Jul. 8, 2004

(54) Database method and system employing data translation capabilities

(75) Inventor: Chii-Hwang Chang, Pingjen City (TW)

Correspondence Address: TUNG & ASSOCIATES, Suite 120, 838 W. Long Lake Road, Bloomfield Hills, MI, 48302, US

(73) Assignee: Taiwan Semiconductor manufacturing Co., Ltd.

(21) Appl. No.: 10/336,408

(22) Filed: Jan. 3, 2003

(51) Int. Cl. G06F 17/00

(52) U.S. Cl. 707/103 Y

(57) ABSTRACT

A database system within a microelectronic fabrication facility and a method for operating the database system within the microelectronic fabrication facility each employ a database translator for purposes of generating a series of database objects from a relational database for operation within an object oriented application program. The database translator also provides an option for confirming the content of the series of database objects.

### BACKGROUND OF THE INVENTION

1. Field of the Invention

The present invention relates generally to database methods and systems. More particularly, the present invention relates to database methods and systems with enhanced capabilities.

2. Description of the Related Art

Microelectronic product fabrication facilities, such as semiconductor product fabrication facilities, generally require sophisticated database systems for efficient operation. Such systems often accumulate data related to large numbers of products and fabrication tools, such as to provide a wealth of data and information for evaluation within the context of product performance and processing trends.

While such data and information are clearly desirable within microelectronic product fabrication facilities and often essential for providing improved microelectronic product performance and yields, the acquisition and use of such data and information is nonetheless not entirely without problems.

In that regard, since microelectronic product fabrication facilities typically provide for continuous enhancements in fabrication tools and associated data acquisition systems and software, it is often difficult to effectively and efficiently access all data and information continuously through a useful life of a microelectronic product fabrication facility.

It is towards the foregoing object that the present invention is directed.

Various methods, apparatus and systems have been disclosed within the information technology art for providing effective access to data and information.

Included but not limiting among the methods, systems and apparatus are those disclosed within: (1) Henninger et al., in U.S. Pat. No. 5,499,371 (a method and apparatus for automatically generating object oriented code for mapping information between an object oriented application and a structured database, such as a relational database); (2) Burroughs et al., in U.S. Pat. No. 6,076,090 (a method and system for persisting an object in a relational database schema); and (3) Ng et al., in U.S. Pat. No. 6,360,223 (a method and apparatus which employ mapping rules for mapping data between a relational model and an object model).

The teachings of each of the foregoing references are incorporated herein fully by reference.

Desirable are additional methods, systems and apparatus which provide for effective access to data and information within microelectronic fabrication facilities.

It is towards the foregoing object that the present invention is directed.

### SUMMARY OF THE INVENTION

A first object of the invention is to provide a method and a system which provides for access to data and information within a microelectronic fabrication facility.

A second object of the invention is to provide a method and a system in accord with the first object of the invention, wherein the data and information is effectively accessed within the microelectronic fabrication facility.

In accord with the objects of the invention, the invention provides a method for operating a database system.

The method of the invention first provides a database system comprising: (1) a relational database; (2) an object oriented application program intended to operate upon a series of database objects derived from the relational database; and (3) a database translator which ascertains the content of the series of database objects from the object oriented application program and generates the series of database objects from the relational database, where the database translator further provides an option to confirm the content of the series of database objects. The method also provides for confirming the content of the series of database objects. Finally, the method provides for operating the object oriented application program.

The method is particularly applicable within the context of a microelectronic fabrication facility.

A system in accord with the invention derives from the method in accord with the invention.

The invention provides a method and a system which provide for efficient access to data and information within a microelectronic fabrication facility.

The method and the system realize the foregoing object by employing within a database system within the microelectronic fabrication facility which comprises a series of fabrication tools, a database translator which translates data from a relational database into a series of database objects for operation by an object oriented application program, where the database translator further provides an option to confirm content of the series of database objects.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic block diagram of a system in accord with the invention.

FIG. 2 shows a series of lines of SQL code which may be employed for making a database inquiry not in accord with the invention.

FIG. 3 and FIG. 4 show a pair of graphical user interface (GUI) screens illustrating an option for confirming database object content in accord with the invention.

### DESCRIPTION OF THE PREFERRED EMBODIMENT

The invention provides a method and a system which provide for efficient access to data and information within a microelectronic fabrication facility.

The method and the system realize the foregoing object by employing within a database system within the microelectronic fabrication facility a database translator which translates data within a relational database into a series of database objects for operation by an object oriented application program. Within the invention, the database translator further provides an option to confirm content of the series of database objects.

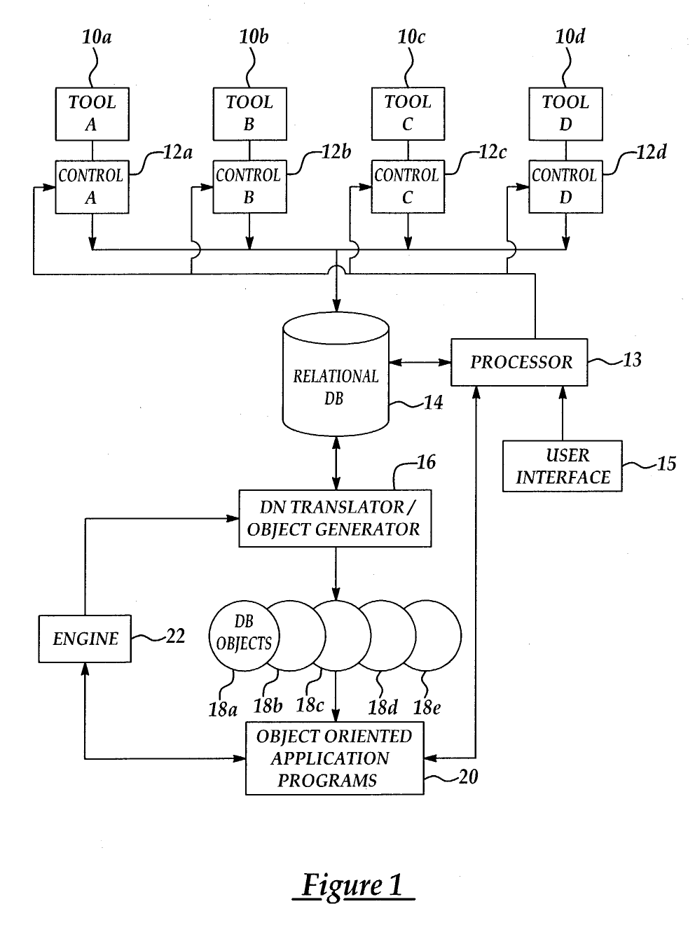

FIG. 1 shows a schematic block diagram of a system in accord with the invention.

FIG. 1 first illustrates a series of fabrication tools 10a, 10b, 10c and 10d which may be employed within a microelectronic fabrication facility for fabricating a microelectronic product therein. Within the invention, the microelectronic fabrication facility may be selected from the group including but not limited to semiconductor product fabrication facilities, ceramic substrate product fabrication facilities and optoelectronic product fabrication facilities. The foregoing fabrication facilities provide corresponding semiconductor products, ceramic substrate products and optoelectronic products. In addition, each of the series of fabrication tools 10a, 10b, 10c and 10d may be selected from the group including but not limited to metrology tools and processing tools. Metrology tools may include, but are not limited to, physical measurement tools as well as electrical measurement tools. Processing tools may include, but are not limited to dry processing tools, wet processing tools, deposition processing tools and etch processing tools.

Associated with each one of the series of fabrication tools 10a, 10b, 10c and 10d as illustrated in FIG. 1 is a corresponding series of tool controllers 12a, 12b, 12c and 12d. Within the invention, the series of tool controllers 12a, 12b, 12c and 12d is intended not only to provide computer assisted operating control of the series of fabrication tools 10a, 10b, 10c and 10d, but to also serve as a conduit through which tool operating parameters, parametric limitations and measured parameter values may be communicated to a relational database 14 where they may be stored. The relational database 14 is otherwise generally conventional within the context of information systems and data acquisition. The relational database 14 generally comprises tables of data organized in conventional row and column format such as to provide data arranged in fields and records. The relational database 14 may be a conventional product (such as a product of Oracle Corporation, a DB2 type database or an SQL Server type database, where the foregoing descriptions may also serve as trademarks).

As is further illustrated within FIG. 1, a processor 13 in turn controls the series of controllers 12a, 12b, 12c and 12d. As is also illustrated in FIG. 1, the processor 13 may further independently access the relational database 14, such as to directly process data and information therein. As is also illustrated in FIG. 1, the processor 13 has further associated therewith and connected thereto a user interface 15 which comprises any of several user interface devices as are conventionally known in the art, such as but not limited to graphical user interface (GUI) devices, keyboard user interface devices and mouse type pointing user interface devices, such as to provide for user interaction with and operation of the system as illustrated within FIG. 1.

As is understood by a person skilled in the art, the relational database 14 as illustrated in FIG. 1 provides an established and conventional, but nonetheless generally rigid and inflexible, means for data storage and retrieval. Typically, data and information stored within a relational database are accessed while employing an application program which in turn employs a structured query language (SQL) source coding of a query to the relational database. Such SQL coded queries are often difficult to write and difficult to maintain, thus providing an enhanced possibility of application program malfunction. More recent advances have provided for object oriented database programming rather than relational database programming. Object oriented database programming provides advantages insofar as data is grouped within the context of related or requested clusters of data and/or information rather than within rigid tables. However, application programs which are written in an object oriented database coding format are generally unable to directly access data and information stored within a relational database.

Thus, FIG. 1 illustrates with respect to an object orientated application program 20 which is under control of the processor 13 the use of a software engine 22 which in turn drives a database translator/object generator 16. As is illustrated in FIG. 1, the database translator/object generator 16 provides from the relational database 14 a series of database objects 18a, 18b, 18c, 18d and 18e which may in turn be accessed, read and manipulated by the object oriented application program 20, under circumstances where data and information within the relational database 14 itself may not directly be so accessed, read and manipulated.

Within the invention, the object oriented application program 20 may be directed towards any of several applications within the context of use of the series of fabrication tools 10a, 10b, 10c and 10d within a microelectronic fabrication facility. Such applications may include, but are not limited to, tool utilization applications, tool scheduling applications, tool maintenance applications.

Within the invention, the software engine 22 and the database translator/object generator 16 may be an integral part of an object oriented application program or in the alternative they may be supplied as a utility separate from an object oriented application program.

As to operation of the software engine 22 and the database translator/object generator 16, it is intended that the software engine 22 makes an inquiry of the object oriented application program 20 as to the nature and content of database objects that the object oriented application program 20 needs in order for proper and effective operation of the object oriented application program 20. The software engine 22 in turn drives the database translator/object generator 16 to access the proper fields and records within the relational database 14 and extract therefrom the appropriate data and information for presentation in the form of the database objects 18a, 18b, 18c, 18d and 18e. Within the invention, the series of database objects 18a, 18b, 18c, 18d and 18e is provided in source code such that they may be readily accessed, read and manipulated. As is discussed in greater detail below, the database translator/object generator 16 also provides for confirmation of the content of the series of database objects 18a, 18b, 18c, 18d and 18e, such as to assure proper and effective operation of the object oriented application program.

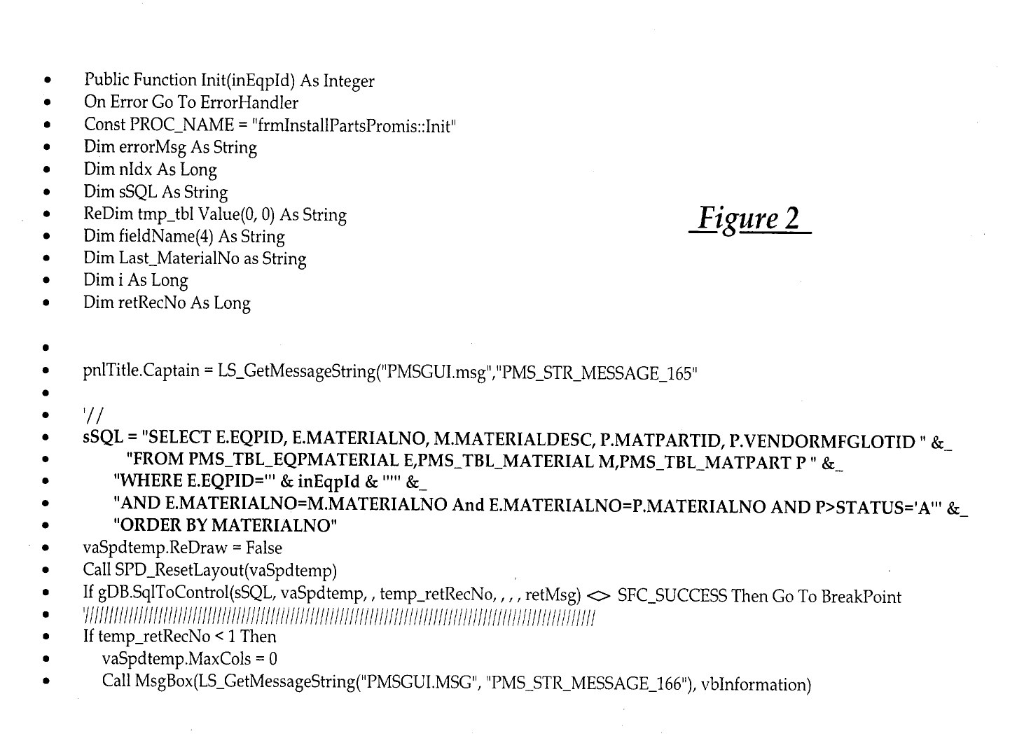

FIG. 2 shows a portion of a program which is written in an SQL coding, which is intended to access data stored within a relational database for purposes of microelectronic fabrication facility tooling analysis. As is illustrated towards the middle of the program listing code, an SQL coded relational database query (i.e., the series of lines beginning with sSQL) provides a lengthy and complex query which is susceptible to coding errors and may require extensive maintenance.

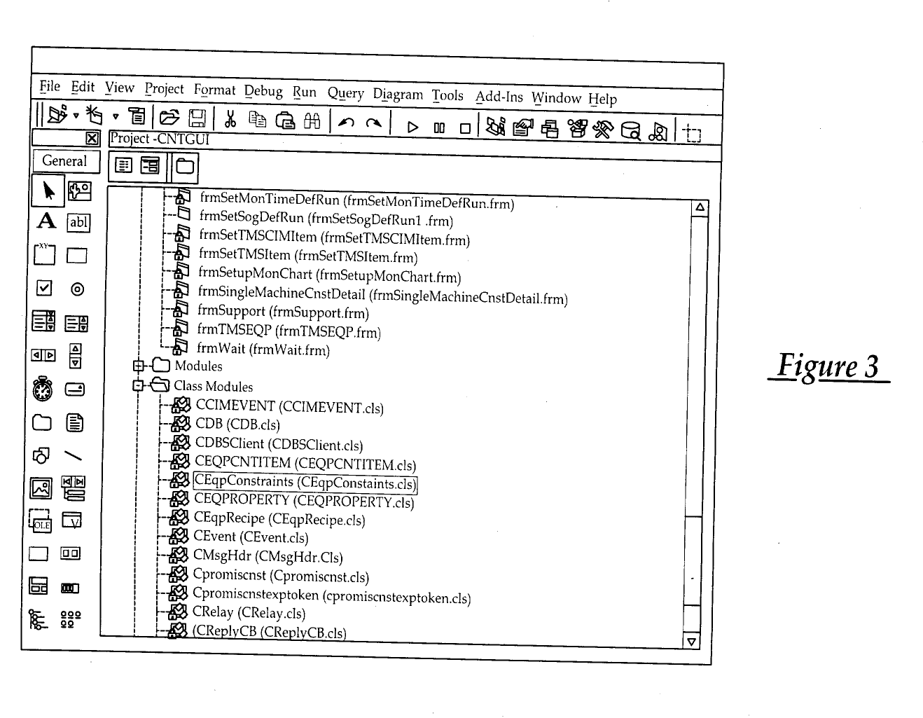

In comparison, FIG. 3 shows a representation of a graphical user interface (GUI) screen employed within the context of an object oriented application program in accord with the invention. As is illustrated in FIG. 3, the graphical user interface provides a listing of class modules (i.e., database objects) that are generated by a database translator/object generator in accord with the invention. Within FIG. 3 a class module CEqpConstraints, which is directed towards fabrication tooling equipment constraints within a microelectronic fabrication facility, is highlighted.

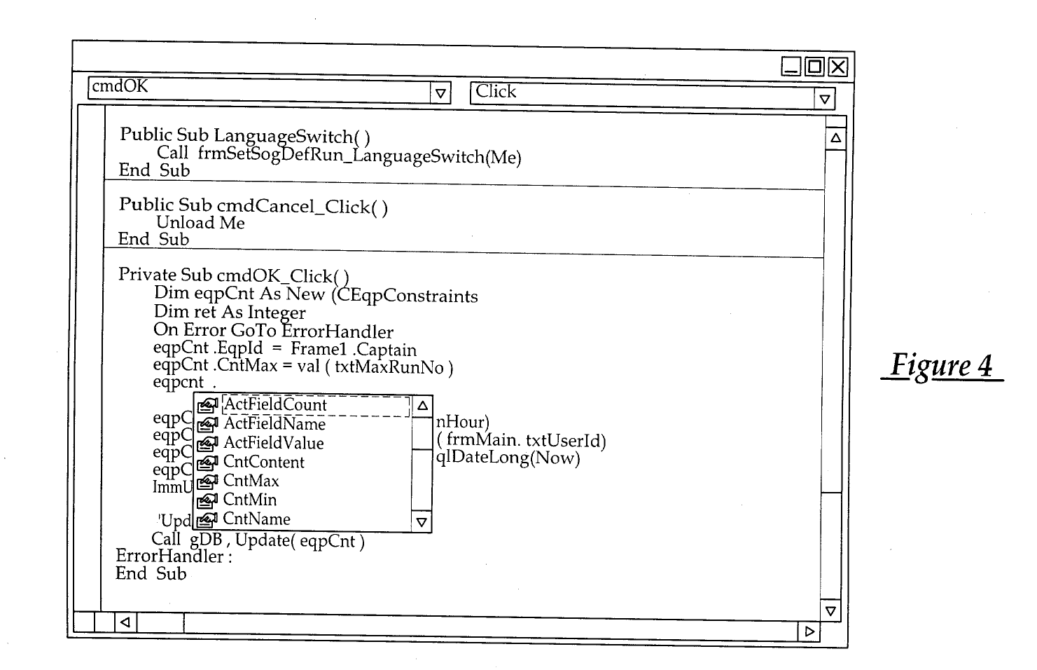

FIG. 4 show a graphical user interface screen which results from access to the highlighted CEqpConstraints class as illustrated in FIG. 3. As is illustrated in FIG. 4, a secondary interior window provides a listing of fields from a relational database which were accessed and translated when generating the class module database object CEqpConstraints for access and manipulation within the object oriented application program. Thus, within the invention, a programmer or a user of an object oriented application program may determine that an accurate translation of data has been effected, thus assuring accurate operation of the object oriented application program.

The preferred embodiment of the invention is illustrative of the invention rather than limiting of the invention. Revisions and modifications may be made to components within the system of the preferred embodiment of the invention, while still providing a method in accord with the invention and a system in accord with the invention, further in accord with the accompanying claims.

What is claimed is:

1. A method operating a database system comprising:
providing a database system comprising:
a relational database;
an object oriented application program intended to operate upon a series of database objects derived from the relational database;
a database translator which ascertains the content of the series of database objects from the object oriented application program and generates the series of database objects from the relational database, where the database translator further provides an option to confirm the content of the series of database objects;
confirming the content of the series of database objects; and
operating the object oriented application program.

2. The method of claim 1 wherein the series of database objects is provided in source code.

3. The method of claim 1 wherein the database translator is integral to the object oriented application program.

4. The method of claim 1 wherein the database translator is independent of the object oriented application program.

5. The method of claim 1 wherein the relational database is a DB2 type database.

6. The method of claim 1 wherein the relational database is an SQL Server type database.

7. A method operating a database system within a microelectronic fabrication facility comprising:
providing a microelectronic fabrication facility having a series of fabrication tools which is connected to a database system, the database system comprising:
a relational database;
an object oriented application program intended to operate upon a series of database objects derived from the relational database;
a database translator which ascertains the content of the series of database objects from the object oriented application program and generates the series of database objects from the relational database, where the database translator further provides an option for a user thereof to confirm the content of the series of database objects;
operating the series of fabrication tools to provide data within the relational database;
confirming the content of the series of database objects; and
operating the object oriented application program.

8. The method of claim 7 wherein the series of database objects is provided in source code.

9. The method of claim 7 wherein the database translator is integral to the object oriented application program.

10. The method of claim 7 wherein the database translator is independent of the object oriented application program.

11. The method of claim 7 wherein the relational database is a DB2 type database.

12. The method of claim 7 wherein the relational database is an SQL Server type database.

13. The method of claim 7 wherein object oriented application program is a tool utilization program.

14. The method of claim 7 wherein the object oriented application program is a tool scheduling program.

15. The method of claim 7 wherein the object oriented application program is a too maintenance program.

16. A microelectronic fabrication facility data system comprising:
a series of fabrication tools; and
a database system, the database system comprising:
a relational database;
an object oriented application program intended to operate upon a series of database objects derived from the relational database;
a database translator which ascertains the content of the series of database objects from the object oriented application program and generates the series of database objects from the relational database, where the database translator further provides an option to confirm the content of the series of database objects.

17. The method of claim 15 wherein the series of database objects is provided in source code.

18. The method of claim 15 wherein the database translator is integral to the object oriented application program.

19. The method of claim 15 wherein the database translator is independent of the object oriented application program.

20. The method of claim 15 wherein object oriented application program is selected from the group consisting of a tool utilization program, a tool scheduling program and a tool maintenance program.
